(19) United States
(12) Patent Application Publication
(10) Pub. No.: US 2022/0312691 A1
(43) Pub. Date: Oct. 6, 2022

(54) Method for raincloud formation using airborne dimethylamine injection

(71) Applicant: James Brian Mitchell, Rennes (FR)

(72) Inventor: James Brian Mitchell, Rennes (FR)

(21) Appl. No.: 17/218,296

(22) Filed: Mar. 31, 2021

(51) Int. Cl. A01G 15/00

(52) U.S. Cl. CPC A01G 15/00

(57) ABSTRACT

Raincloud formation depends on the creation of Cloud Condensation Nuclei (CCN) around which water molecules cluster, generating a nano-particles (nano-cluster), then a micro-cluster and finally a water droplet. A collection of such water droplets constitutes a cloud which may spontaneously produce precipitation (in the form of rain, hail or snow) or precipitation induced by cloud seeding. The CCN is the result of nucleation processes. In this patent application, a process is described wherein said nucleation is catalyzed by the injection of a chemical substance, dimethylamine, into the upper atmosphere, preferably through injection of said substance into an electron rich aircraft engine exhaust. The subsequent formation of negatively charged ions has a catalytic effect on the generation of said CCNs.

### BACKGROUND TO THE INVENTION

Rain is formed via a vapor-to-liquid phase change in the upper atmosphere induced by the process of nucleation and cluster growth leading to the formation of cloud condensation nuclei (CCN). Nucleation is a process actively researched in areas such as atmospheric chemistry, interstellar chemistry, combustion, plasmas and other environments where liquid/solid particles form. A suggestion that cloud nucleation can be affected by cosmic rays and the solar wind led to the creation of an experimental programme at CERN (European Centre for Nuclear Research) in which a high energy charged particle beam is introduced into an instrumented environmental chamber, and its effect on cloud formation is studied [Ref 1]. This experiment is reminiscent of the well-known Wilson cloud chamber, used in the early days of atomic and nuclear physics, where supersaturated water vapor is seen to produce visible tracks of droplets when a charged particle beam passes through it.

The water molecule (H₂O) is highly polar and though itself neutral, positive and negative charges collect at the hydrogen and oxygen locations respectively. This means that these molecules have a tendency to cluster together forming aggregated structures such as (H₂O)ₙ where n is the number of H₂O molecules in the aggregate (commonly known as a “cluster”). The polarisation forces between neutral molecules are rather weak however and small clusters easily fall apart (dissociate) under the influence of, for example, thermal agitation. Thus, clusters typically form under low temperature conditions such as in supersonic molecular jets. It is well known in atomic and molecular physics, that ionised clusters have much higher binding energies and hence are thermodynamically more stable structures. For example, when ionised by the input of external energy, for example in a collision with electrons or other photons or other energetic particles, the positively charged ion, H₂O⁺ is formed but it can rapidly react with other water molecules to form the hydronium ion H₃O⁺ via the reaction:

H₂O⁺+H₂O→H₃O⁺+OH, I

Hydronium in turn can react via three-body collisions such as:

H₃O⁺+H₂O+X→H₃O⁺(H₂O)+X, II

where X may be another water molecule, the third body carrying away excess energy in the process,

The cluster ion H₃O⁺(H₂O) formed in Reaction II can repeat this type of process to form H₃O⁺(H₂O)₂ and so on until a large cluster H₃O⁺(H₂O)ₙ is formed where n is the number of H₂O molecules attached to the hydronium ion.

Such a cluster can be neutralised by the process of dissociative recombination with electrons, thus

H₃O⁺(H₂O)ₙ+e→H₃O⁺(H₂O)ₙ₋₁+H₂O, III

Some of the so-called “recombination energy” of the ionised cluster (essentially the energy required to ionise the structure) being converted into kinetic energy of the separating fragments (some of which can be internally excited rotationally, vibrationally and/or electronically).

The cluster can also be neutralised by a so-called “ion-ion” collision with a negative ion, Z⁻ thus, for example:

H₃O⁺(H₂O)ₙ+Z⁻→H₃O⁺(H₂O)ₙ₋₁+Z+H₂O, IV

Both charged species being neutralised in the process. At some scale, the cluster may be so large that the release of a fragment (in the above examples, an H₂O molecule), carrying away excess recombination energy, may not be necessary and the cluster may be able to absorb said energy by internal ro-vibrational excitation. Though expected, the details of such an event are not known to persons skilled in atomic and molecular physics, said event not having been observed in the laboratory at this time. However it is known that if n is sufficiently large, the neutral cluster thus formed can be stable and can go on to accumulate other neutral molecules such as H₂O, eventually producing a nanoparticle (liquid or solid depending on the local thermodynamic conditions of temperature and pressure), then a microparticle and eventually a water or ice droplet (macroparticle) though processes of accretion (the deposition of material) and coalescence (the joining together of different nanoparticles or micro or macroparticles). (The terms “nano” and “micro” referring to typical dimension scales of the particles as measured in nanometers (10⁻⁹ m) or microns (10⁻⁶ m)).

Sulfuric acid (H₂SO₄) has been identified as a major factor in atmospheric nucleation in the formation of cloud condensation nuclei (CCN) which are precursors of droplet formation. The sulfuric acid is formed via the oxidation of sulphur dioxide (SO₂) occurring naturally or as a result of industrial and combustion processes by hydroxyl (OH) radicals, formed photochemically. The H₂SO₄ thus formed, aggregates with water to form clusters of growing size, the clustering rate being enhanced by interaction with other species such as ammonia, amines and extra low volatile organic compounds (ELVOCS) such as pinenes etc, emitted by forests.

The process of ion-ion neutralisation in particular, has been identified as an important step in neutral cluster growth and the stability of the resulting structure is critical for further growth. Sulfuric acid (H₂SO₄) has been identified as a precursor to macroparticle formation and it can be ionised positively (by photoionization or other energetic ionization processes) to form H₂SO₄⁺ (or associated positive fragment ions with loss of atoms) or negative ions H₂SO₄⁻ (or associated negative ions). While there are extensive discussions in the literature of how such processes occur, very little attention has been paid by those skilled in the art of atmospheric chemistry, to the actual mechanism of formation of said negative ions. Indeed, this is a subject which falls into the domain of atomic and molecular physics.

While any atom or molecule can be ionised positively by the interaction with energetic photons, electrons or heavy particles (accelerated ionised particles or internally excited heavy particles), negative particle formation is a much more delicate process. Positive ionization involves the violent introduction of several electron volts to tens of electron volts of energy for the production of singly charged positive ions (e.g. 3.89 eV for cesium, 13.6 eV for hydrogen, 24.59 eV for helium), negative binding energies are typically much lower (0.75 eV for hydrogen, 1.46 for oxygen, 2.1 eV for sulfur, 3.6 eV for chlorine). Furthermore, in order to bind an electron, the atom (or molecule) must be electronegative (i.e. it must exhibit a positive binding energy with respect to electrons). For example, nitrogen atoms do not form negative ions, though NH radicals have a positive binding energy of 0.38 eV and NH2, has a positive binding energy of 0.76 eV.

The capture of an electron by an atom or a molecule is a much more subtle process, often involving the formation of an intermediate excited state or resonance which subsequently is stabilised by an energy transfer process. A complete review of this subject is outside the scope of the present request, but more information can be found in standard atomic and molecular texts (e.g. refs. 2, 3). One such process that will be discussed here, and which is perhaps the most important negative ion formation process, is the so-called electron attachment process in which a free electron is captured by a molecule forming a negative ion. This can occur in two ways, dissociatively and non-dissociatively. In the former case, a molecule which we shall call AB, where A and B may be atoms of molecular fragments, captures an electron and subsequently breaks up into individual fragments A and B⁻ or A⁻ and B, thus:

e+AB→A+B⁻, IVa

e+AB→A⁻+B, IVb

Whether both IVa and IVb occur depends the ability of A and/or B to form negative ions A⁻ or B⁻.

The dissociation, i.e. the breaking of the molecule into fragments which carry away kinetic energy, is a very effective means of removing the excess energy representing the difference in the internal binding energy of the molecule AB and that of the negative ion, A⁻ or B⁻.

Non-dissociative electron attachment generally involves larger molecules where the excess energy of the reaction can be temporarily stored within the newly formed negative ion, as ro-vibrational excitation. In order to become permanently stable, this excess internal energy must be removed by a third body (via a collision) or possibly radiatively (by the emission of a photon which carries away the energy). In this case there is a competition between the lifetime of the excited negative ion against autodetachment (of the electron) and stabilisation via collision (depending on the local thermodynamic conditions of temperature and pressure) or radiation (typically a slow process compared to excited state autodetachment lifetimes).

In the present, process IVa,b, the so-called dissociative attachment process is discussed. This process as described quantum mechanically, involves the transition from the bound, ground state of the molecule (i.e. the natural ro-vibrational state under the given thermodynamic conditions of temperature and pressure of the molecule's environment, hereafter referred to as the “ground state”) and an upper repulsive state, lying above the ground state by an amount equal to the energy of the incoming electron. Once in this state, the electron capture is stabilised by the system following this repulsive state down to an internuclear distance which is below the energy level of the ground state, so that return to said state is impossible. The now free fragments carry away with one of them, the attached electron. For many molecules, if such an excited repulsive state exists at all, it lies at one or more electron volts above the ground state. In this case, the kinetic energy of the incoming electron plays a critical role on the likelihood of the reaction progressing.

It is known from atomic and molecular theory and experiment [Ref. 2,3], that the cross section for electron attachment (i.e. a measure of the probability of the process occurring), depends critically on the energy of the incoming electron and that the most likely attachment is one in which the electron has zero (or near-zero) incoming kinetic energy. This fact means that cross-section (and therefore reaction rates) for electron attachment process can vary by many orders of magnitude.

The reason for the above discussion is that it is clear that, in order to be an important player in the field of nucleation involving negative ions, whether for initial triggering or for the stabilisation of the clustering process, the species in question must be able to easily and rapidly produce negative ions.

Returning to the experiment at CERN mentioned at the beginning of this section, during said experiment, investigating the nucleation of water droplets in an environmental chamber containing water vapor, it was found that the presence of dimethylamine at a concentration of parts per trillion, increased the nucleation rate by up to four orders of magnitude. Dimethylamine (hereafter DMA) is a natural substance produced by rotting fish but also by the photochemistry of ammonia in the atmosphere, said ammonia being emitted by plant matter. It has the chemical formula ((CH₃)₂NH. In the original paper describing this finding [Ref.1], the reason for the activity of DMA was not discussed or explained. However, the activity was not attributed to ion-induced effects as sulfuric and DMA neutral clusters are very stable. In a subsequent publication [Ref.4], the action of DMA was discussed in more detail and the efficiency of DMA for cluster formation is attributed to a stabilising effect where DMA hinders cluster evaporation. In this article, this stabilisation is not attributed to charged particle effects. Ion-induced cluster formation enhancement is considered to be important in the absence of sulfuric acid and DMA [Ref.4].

In an experiment performed at the Universite de Rennes I, in 2017, it was found that DMA attaches electrons efficiently at low electron energies (0.027 eV) corresponding to room temperature of 300K [Ref. 6]. This was a surprising observation and one that had not been made previously in the laboratory. (Trimethylamine (CH₃)₃N was also studied and was found not to attach electrons at room temperature). It was also found that DMA readily formed cluster ions of the type DMA⁺(DMA)ₙ. This provides a clue as to why DMA is particularly efficient at inducing clustering and thus nucleation in the upper atmosphere. The negative charge on the fragments and clusters produced by the electron attachment to DMA, means that it can readily attach polar water molecules forming nuclei for subsequent nanoparticle, microparticle and macroparticle formation. It should be noted that electron attachment to ammonia, a precursor to DMA formation in the atmosphere occurs, via resonant processes centred at 5.5 and 10.5 eV and thus with much lower reaction probabilities. [Ref. 7]. Sulfuric acid also attaches electrons efficiently at room temperature [Ref. 8] readily forming cluster ions which also undergo low energy electron attachment [Ref. 9].

It should be remembered that electron densities in the troposphere are very low and therefore in the undisturbed atmosphere, it might be expected that the ion forming ability of DMA might be considered as secondary to its ability to stabilise sulfuric acid-DMA clusters.

The ability for DMA to form nanoparticles has recently been demonstrated in recent (unpublished) plasma experiments (with much higher electron densities (10⁸-10⁹ cm⁻³) where DMA was injected at several percent by volume, into an argon radiofrequency generated plasma (0.5 mbar pressure) with the resulting immediate formation of nanoparticles. Such nanoparticles are caused because negative ions formed by attachment to electronegative species are trapped in the positive well of the plasma potential, said trapped ions clustering to form said nanoparticles. This does not form part of this patent request but provides evidence for the effectiveness of DMA as a nucleating agent.

### BRIEF SUMMARY OF THE INVENTION

Based on the ability of dimethylamine to cluster and to capture electrons efficiently, it is proposed to inject dimethylamine (DMA) into the upper atmosphere where it can act as a nucleating agent for the formation of cloud condensation nuclei (CCN). It is also proposed to perform the injection of DMA into the exhausts of aircraft engines as these are a source of electrons which will participate in the DMA electron capture process. The purpose of this exercise is to generate clouds which will serve to (a) reflect sunlight and (b) potentially produce precipitation.

### DETAILED DESCRIPTION OF THE INVENTION

### First Embodiment

As a first embodiment a system is proposed in which dimethylamine (DMA) vapor is released from aeroplane at moderate to high altitude (preferably between 1000 and 25000 feet) with the purpose of catalysing the nucleation of water vapor so as to form nano-clusters, micro-clusters and eventually macro-clusters of water (CCN) which will subsequently form a cloud capable of precipitating liquid water in the form of rain. Such clouds also act as a means to reflect sunlight thus producing a cooling effect in the lower atmosphere. Dimethylamine is chosen as catalyst because of its ability to capture electrons at low temperatures thus forming negative ions which are known to be highly effective nucleating agents. The dimethylamine can be carried aloft in pressurized cylinders which are then opened by means of a solenoid valve and ejected through a spray nozzle or a plurality of spray nozzles which will provide a diffuse mist of said DMA vapor over wide area. This is rather similar to the formation of contrails from aircraft engines, said contrails being nucleated by soot particles emitted from the combustion of the aircraft engine fuel.

### Second Embodiment

In a second embodiment, the DMA will be injected into the exhaust of the engines of the aircraft carrying said DMA aloft. The reason for this, is that the natural electron concentration in the upper atmosphere is low (a few cm³) and to be effective, it is preferable that the DMA can rapidly encounter electrons so as to form negative ions to act as nucleating agents. It is known to a person skilled in the art, that aircraft engines emit free electrons and ions in their exhausts with concentrations on the order of (10⁸-10¹⁰ cm⁻³) [ref. 10]) and so said electrons can become attached to the DMA molecules injected into the engine exhaust gas stream which is in fact a plasma environment, i.e. an environment containing free electrons and positive and negative ions. Said source of electrons will enhance the ability of DMA to catalyse the nucleation of water vapor.

The choice of environmental conditions, altitudes etc. can be made by a person skilled in the art of cloud seeding, i.e. the deliberate seeding of existing clouds with particles, typically silver nitrate particles, which act as physical nucleating agents, the purpose of said seeding being to stimulate the nucleation and growth of water droplets so that they can precipitate out from the cloud as rain.

### REFERENCES

1. J. Almeida et al., Nature 502, 359 (2013)
2. McDaniel, E. W., Mitchell, J. B. A. and Rudd, M. E. (1993) Atomic Collisions: Heavy Particle Projectiles, J. Wiley and Sons Inc., New York.
3. Electron-Molecule Interactions and Their Applications., L. G. Christophorou (Ed.), Academic Press, N.Y.
4. A. Kurten et al., Proc. Nat. Acad. Sci. 42, 15019 (2014)
5. K. Lahtpalo et al., Nature. Comm. 7, 11594, 2016
6. S. Al Shammari, PhD Thesis, Univ. de Rennes 1 (2018)
7. N. Bhargava and E. Krishnhumar, J. Chem. Phys. 136, 164308 (2012)
8. N. G. Adams et al., Chem. Phys., 84, 6728 (1986)
9. J. Lengyel et al., Atmos. Chem. Phys., 17, 14171 (2017)
10. A. Sorokin et al. Atmospheric Chem. and Phys. 3, 325 (2003)

1. Method for the enhancement and stabilization of nucleation of water vapor by injection into the air of dimethylamine (DMA) into the troposphere at a height appropriate for the formation of rain clouds leading to the formation of cloud condensation nuclei.

2. Method according to claim 1, characterised in that the method is performed by first injecting DMA into the exhaust of an airplane engine, said exhaust being an appropriate plasma environment, containing electrons and ions, so that said DMA is more able to acquire a negative charge by capture of said electrons, thus enhancing the ability of DMA to nucleate with other environmental species, particularly water molecules, or ions and sulfuric acid molecules, or ions.
